(19) United States
(12) Patent Application Publication
(10) Pub. No.: US 2012/0166316 A1
(43) Pub. Date: Jun. 28, 2012

(54) Collective community Method of Integrated Internet-Based tools for Independent Contractors, their Collaborators, and Customers

(76) Inventors: Richard Angelo Messina, Avon, CT (US); Elizabeth Ann Messina, Avon, CT (US)

(21) Appl. No.: 13/412,973

(22) Filed: Mar. 6, 2012

Related U.S. Application Data
(63) Continuation of application No. 11/837,519, filed on Aug. 11, 2007, now abandoned.
(60) Provisional application No. 60/822,136, filed on Aug. 11, 2006.

(51) Int. Cl. G06Q 30/06

(52) U.S. Cl. 705/27.1

(57) ABSTRACT

The present invention is a web-based business method that provides its collective members with integrated tools and services to collaborate, produce, direct-market and monetize their skills, works and professional expertise to a direct-to-consumer or business-to-business market.

### CROSS REFERENCE TO RELATED APPLICATIONS

This application claims priority from and is a Continuation of U.S. patent application Ser. No. 11/837,519, entitled “Collective community Method of Integrated Internet-Based tools for Independent Contractors, their Collaborators, and Customers”, filed on Aug. 11, 2007, which is incorporated by reference in its entirety for all purposes as if fully set forth herein.

U.S. patent application Ser. No. 11/837,519 claims priority from U.S. Provisional Patent Application Ser. No. 60/822,136, entitled “Collective community Method of Integrated Internet-Based tools for Independent Creatives, their Collaborators, and Customers”, filed on Aug. 11, 2006.

### FEDERALLY SPONSORED RESEARCH

Not Applicable

### SEQUENCE LISTING OR PROGRAM

Not Applicable

### TECHNICAL FIELD OF THE INVENTION

The present invention relates generally to business methods. More specifically, the present invention relates to the field of Internet business methods and the systems and services associated with organizing a revenue-generating web-based community of professional independents and collaborators and the consumers of their works and services.

### DEFINITIONS OF SPECIFIC TERMS

The present invention defines its users as: “Pro Members” or “Pro”; “Amateur Members” or “Am”; “Clients”; “Fans”; and “Visitors”.

“Members” are independent professionals, independent contractors, or practitioners of any creative field. PRO—Membership is by application and acceptance by jury of creative professional peers. AMATEUR—Membership is simply paid at a certain level with limited services available. (e.g. Amateur members are not tied into the present invention brand.) “Amateur” Members can interact with Pro Members by arrangement determined by PRO member—either paid or not. Membership may be paid or free depending on level of membership and services. The system enables different interactions between the users of the site based on their member status or classification.

“Clients” are registered users who have been invited by members to collaborate with members to use the present invention tools for purposes of project review, discussion works, editing works, or purchase works and services or subscription to a member's Paid Self Syndicate.

“Fans” are registered users of the site who may set up pages that keep lists of their favorites, purchases they have made on the site, wish lists, comments on works, etc.

“Visitors” refers to the general public who will use the present invention services to browse and shop online, purchase stock works or contact or buy the goods or services of the present invention members.

“Works” refers to the original products created and produced by Members and their collaborators. Works can be commissioned or un-commissioned or stock.

“Services” refers to professional consulting services that are provided by Members.

“Stock” refers to original works that are “in stock” and available for sale and delivery.

“Showcase” refers to the tools and systems of the web site that enable the display and promotion of a Member's works and skills, for example a portfolio and bio. This includes the directories and dynamic search functions, which enable users to find information about Members and their works.

“Workspace” refers to the tools and systems of the web site that enable the provision of services and/or collaboration on projects among Members and other users of the site.

“marketplace” refers to the e-commerce tools and systems of the web site that enable the sale, licensing, sharing and general distribution works and services of the Members.

“community tools” refer to the systems of the web site that enable direct communication, interaction and networking among Members and other users of the site for various purposes.

“Creatives” refers to individuals who are practitioners—either professionally or in an amateur capacity—in a variety of creative disciplines including design, photography, illustration, writing, music, film-making, animation, CGI, programming, etc.

### BACKGROUND OF THE INVENTION

Because of worldwide economic trends in corporate downsizing in which companies are streamlining to focus on their core business objectives, more creatives are entering the market as independent contractors and are in need of business tools to compete. Creative professionals that used to perform specialized tasks while employed at larger corporations find themselves working as independents without the other skills or skilled co-workers needed to produce multi-faceted collaborative projects. These newly independent contractors join the ranks of creatives who have traditionally chosen to practice their crafts and professions as independent business people. In order to compete and earn a living in this climate, it is vitally important to the independent creative professional to market their services and works using Internet technology to facilitate more efficient communication with buyers and distribution of products. It is to the independent's advantage to be associated with a source and a brand that signifies his/her superior quality.

Meanwhile, advances in technology—such as the merging of Internet, television and mobile media—have increased demand for new kinds of multi-media content. Producers of that content have responded by generating a glut of media products available online. The overwhelming volume of media content available through internet sources creates the need for a well-organized and edited source of those works—and the creatives that produce them—so buyers can easily find the superior quality, more entertaining content, and, thus, more valuable works. web sites such as E-lance.com and Guru.com have addressed the buyer's needs through use of a bid-for-work approach, forcing a reduction in rates charged by creatives, and a precipitous devaluing of the works produced and services provided.

The present invention's business model provides essential tools associated with a well-regarded brand by which top-level professional creatives can market their works and services directly to their customers—rather than using the more randomly-organized, general-purpose web community sites such as MySpace.com or Blogspot, etc., for that purpose. Specialized creatives are in a stronger marketing position if they are affiliated with a larger network that connects them with professionals that have other skills and talents and gives them the tools to successfully leverage their own expertise for profit.

Members of the present invention must apply and be accepted for membership through a process of peer review. Buyers of their works benefit by obtaining better works and services with creative independents who are vetted for certain qualifications.

There are several sites available to creatives allowing them some of the functionality the present invention method offers, however they are primarily structured for use by registered users of a specific media or genre—e.g. portfolio sites for visual artists, video display sites for animators and video artists, music download or listening sites for Audio artists, e-book sites and blogs for writers, etc. There are also community features and e-commerce features offered on some of the web sites. All have varying business models and revenue collecting models. None of these sites are set up to integrate portfolio and e-commerce tools with community/networking and collaboration tools that give aggregated members the revenue-building opportunity to work together to create and sell new works they would not make on their own. This invention offers its members the unique ability to upload an original work one time to one location, and tag that work with information and permissions that makes it available for multiple uses and distributions (e.g. display, licensing, sharing, purchase, and ad sponsorship) on multiple web pages and sites.

Members choose whether a work will be distributed for non-profit sharing or for-profit. The invention also allows a creator to track the sales and distribution of his works from the same simple interface.

System administrators of the invention offer and maintain “Project Management Resources” which can refer “replacement” collaborators who can step in to replace team members when they cannot complete a project as agreed.

A Membership Review Board, in addition to performing jury functions for admitting new Pro Members, reviews complaints involving the conduct of Members and other users of the site, and can decide to cancel the access of that user to the site, and refund any appropriate fees or dues.

### SUMMARY OF THE INVENTION

The present invention's tools enable the aggregation of specialized members into a collective community for purposes of working with others to make and sell works they could not make or sell as successfully on their own. The invention allows its members to collaborate on commissioned, speculative or non-commissioned works and to distribute those works directly to consumer or business-to-business markets. The present invention fulfills this need of conveniently integrating several useful and desirable tools and services for members and their customers into an efficient, centrally managed, online community setting. It offers its members multiple ways of promoting themselves and multiple ways of monetizing their works, skills and specialties as part of the online professional community setting and brand. It offers its members a broad marketing and distribution method for their works while tracking sales and other metrics through one centralized location.

The present invention allows for the basic management of intellectual property rights of producers of creative works and their buyers by facilitating agreements as to rights ownership, pricing and revenue sharing before works are created or distributed. It allows for automatic dispersement of shared revenues to collaborators upon sale from the invention's online “stores.” The present invention's advertising-revenue sharing programs add value and incentive for membership in the present invention. The present invention fulfills the need for buyers of creative works and services to find and patronize its members in a central, attractive and easy-to-use online site.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

The attached drawings and flow-charts relate to the current embodiment of the Internet business method as is in development for the present invention. The drawings demonstrate navigation through and among the various tools and indicate the integrated functions and features of the site as described for this Internet business method.

FIG. 1 is a schematic of overall site showing integration of tools and features;

FIG. 2 illustrates the process of becoming a Pro Member and using integrated Showcase tools to promote works and services;

FIG. 3 illustrates the process of Member and/or Client-Member collaboration for profit using integrated tools and features;

FIG. 4 illustrates a process of a Pro Member using marketplace tools to enable multiple sources of revenue including: sale/license works; paid services; paid subscription to original works; ad revenue sharing; collecting donations from ‘patrons’ and ‘fans;’ “Made-With” sponsorship of original works;

FIG. 5 shows the home page states for Showcase and Workspace tools;

FIG. 6 shows the marketplace home page state that promotes works for sale in the general collective store and in the stock/licensed works collection;

FIG. 7 shows the Profile screen menu that toggles to showcase the Pro Member's bio, qualifications, and work methods for collaboration and the Pro Member's Portfolio, Blog, and a link to the Member's own domain web site;

FIG. 8 illustrates a Member's “Creative Control Panel.” Site functions for the Member are controlled through interface with the Creative Control Panel

FIG. 9 illustrates a Pro Member's, page for keeping track of their favorites, receiving and sending messages, and reviewing purchases; Fans and Clients have similar pages with varying options available to them depending on their status.

FIG. 10 illustrates a “Project Studio Workspace” for use by project managers that offers areas for such functions as file and job tracking and discussion about the files;

FIG. 11 illustrates sample text of an electronic mail or message system invitation to collaborate message;

FIG. 12 illustrates the collaboration “Contract Wizard” of the present invention;

FIG. 13 illustrates a “Project Studio” Workspace for the collaborators that offers areas for file and job tracking and discussion about the files;

FIG. 14 illustrates a Pro Member's store screen;

FIG. 15 illustrates the “Paid Self-Syndication” process by which a member offers original works for syndication by paid subscription, either direct-to-consumer or business-to-business for resale or reuse;

FIG. 16 illustrates the general process by which a Pro Member uses the integrated processes of the invention to assemble a multi-discipline team, agree to share profits and rights using the Contract Wizard, complete a project using the Workspace tools, and offer the resulting work for sale on the system web site as well as the Member's own domain sites which are ‘powered’ by the back-end ‘engine” of the invention;

FIG. 17. illustrates the “Upload Once” process by which a single work is uploaded to the site and subsequently tagged with meta data that gives information about the work, sets permission, sets preferences as to display and usage, pricing, rights-management, copyright ownership, “Made With” sponsorship, and is then distributed through the system's and/or Member's stores for sale or licensing, disbursement of sales revenues, etc. all managed by the Creative Control Panel and powered by the system's unique engine; and

FIG. 18 illustrates how the collective aggregation of top-quality Pro Members attracts other users to the invention, thereby creating a dynamic economic and social online community.

### DETAILED DESCRIPTION OF THE INVENTION

In the following detailed description of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

Referring to the figures, it is possible to see the various major elements constituting the apparatus of the present invention. The method of the present invention creates an online collective of professional Independent Contractors from multiple disciplines and specialties. Members of different skill sets will collaborate to produce and sell works that they could not make on their own. These exchanges can be either paid or non-paid depending on the choice of the individual. Pro Membership is by application and review by jury to ensure the quality of professional talent associated with the site's brand.

The invention's unique combination and integration of Internet-based tools and services is for the purpose of streamlining collaborative efforts among members, and making it easy for members to sell or license their original works and/or services direct to consumers and clients, thereby maximizing their earnings potential. These tools and services include: “The Creative Control Panel”, showcase tools, Profile and portfolio pages, customized web sites, workspace tools, Project Studios, marketplace tools, community tools and Ad-Revenue Sharing systems. tools and services are powered by the unique “Engine,” which refers to the back-end integration of databases, search functions, content management, file serving and e-commerce processing, etc.

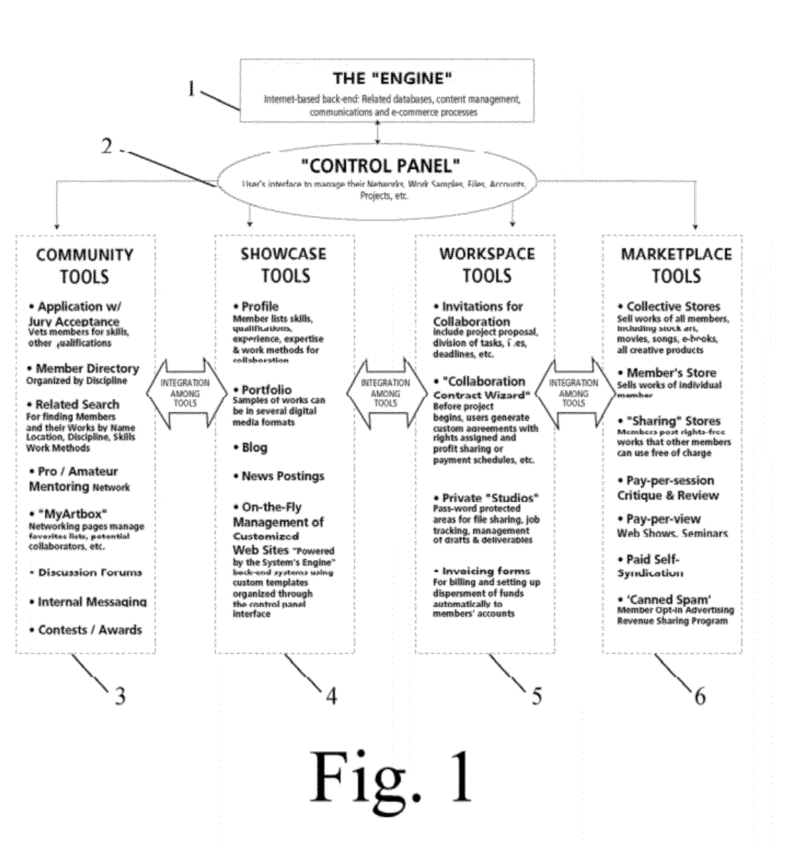

The “Creative Control Panel” is a web-based interface tool that allows members of the present invention community to upload their original digital files to the present invention's server and manage how those files are displayed, shared or sold online FIG. 1 is a wire frame representation demonstrating the function of the Creative Control Panel as the user's interface for the back-end “engine”. Members use the Creative Control Panel interface to manage the permissions and access that other users of the site—based on their status—will have to the Member and his/her works and bio/contact information.

showcase tools enable Members to build and edit portfolios works, post “pod casts” and “video casts” and other electronic or digital works of various formats, and maintain a personal web journal or “blog”. The invention enables a Member to upload a digital file one time and then edit each of these files by setting specific display options, setting permissions, setting prices and managing licenses, copyrights or other usage rights. They can create “slideshows” and collections” works to display, deliver or sell individually or as a group.

A Members' professional information and portfolio—or collections of sample works—are included in an individual “Showcase” page as well as in searchable online listings that help users to locate professionals of specific specialty areas or willingness to work in a specific arrangement. Amateur Members' Showcases and Stores are not part of the Search or public directories. Amateur Members may use the tools of the invention to build a Showcase, but it is not promoted or tied into the invention's brand.

“customized web sites” are controlled by the present invention's backend systems. Members may build customized web sites that resolve to their own domain names that are external to the present invention but are managed and edited using the present invention's backend software tools and may also be tied into the present invention's e-commerce functions.

workspace tools provide members with a collection of integrated software tools, so that members can interact and collaborate with other Members and or their Clients to invent, discuss, develop, critique, project-manage and create works that can be sold from the present invention web site and/or from individual members' or web sites. The present invention offers project management tools such as automated project “Proposals” and “Invitations” and the “Contract Wizard” which facilitates the ability for Members, their collaborators and Clients to establish how rights will be assigned and fees will be dispersed before a work is purchased or a project commences. The present invention offers resources such as professional business advisories on how to bring collaborative works to market using the present invention-managed automated e-commerce accounts to disperse payment to collaborating members.

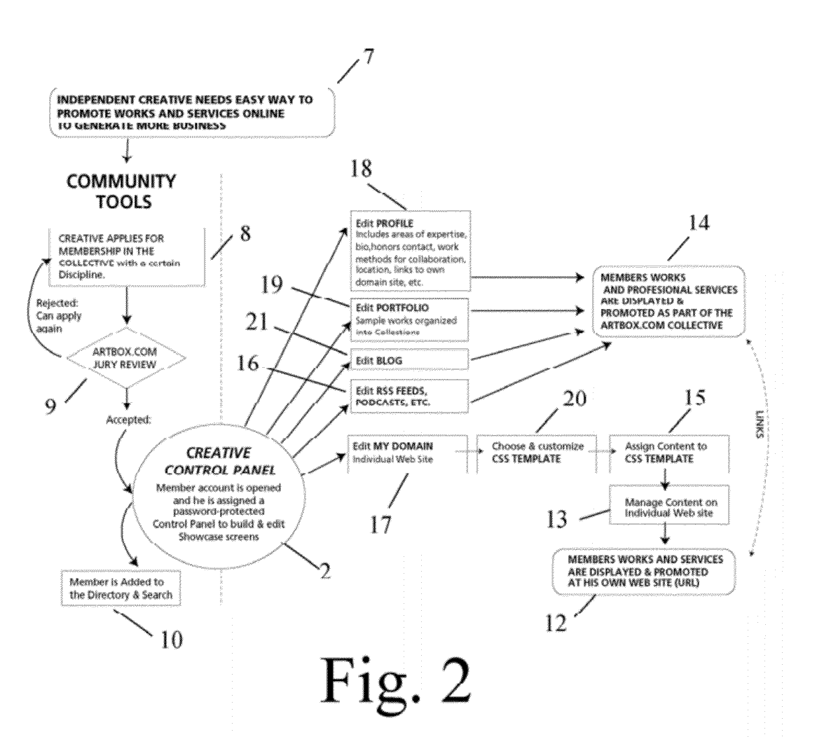

Members can set up “Project Studio” pages and invite members or registered “clients” to password-protected private viewing/listening areas where works in progress or for potential sale can be discussed, tagged, critiqued and posted for download. Members and their invited clients or collaborators can upload files for review to the Project Studio or download files from the Project Studio. Members can use this function to offer their expert review, critique and advice to other members or the public. Members can choose to set this up as a “paid” service. Members can also use this tool for offering paid or free “webinars” or web-based teaching seminars to selected clients or other members. FIG. 2 illustrates one possible embodiment of a Project Studio of the present invention.

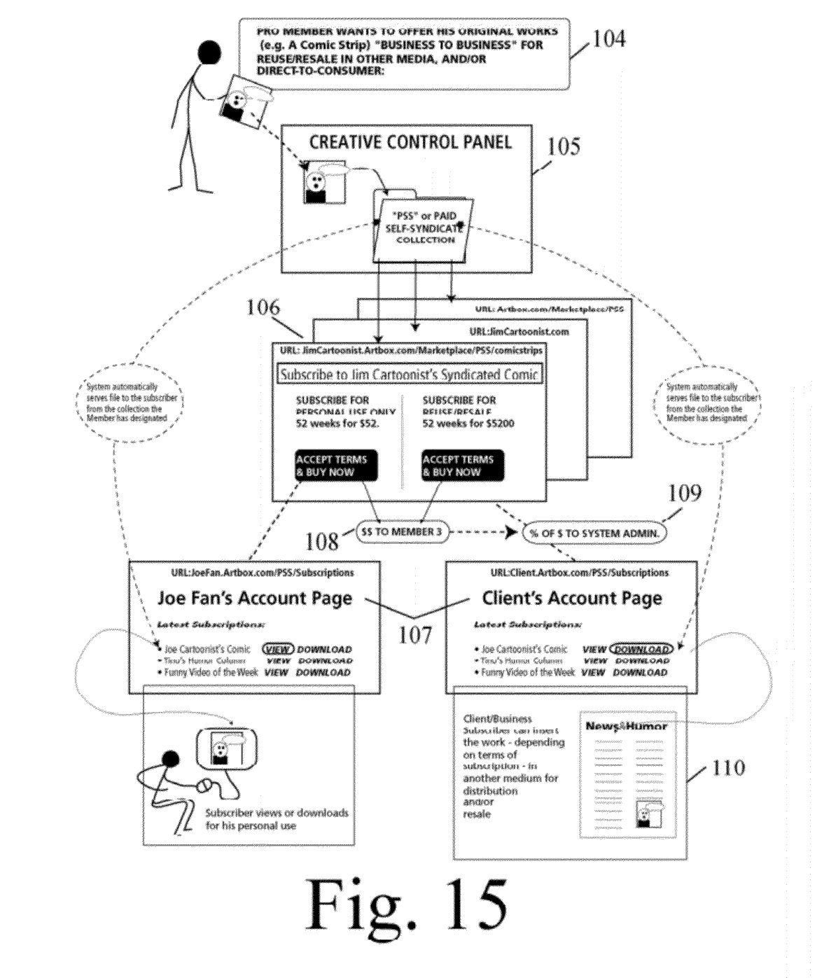

Members, especially those creatives who produce content for media and entertainment, may use Workspace and marketplace tools to market their works as a “PSS”—“Paid Self Syndication.” Clients and Fans may subscribe to a Member's or group of Members' works for pre-negotiated license terms and fee scales, exclusivity, right of first refusal, etc. FIG. 15 illustrates the process by which a member would offer Self-Syndicated original works to buyers using the Workspace and marketplace tools.

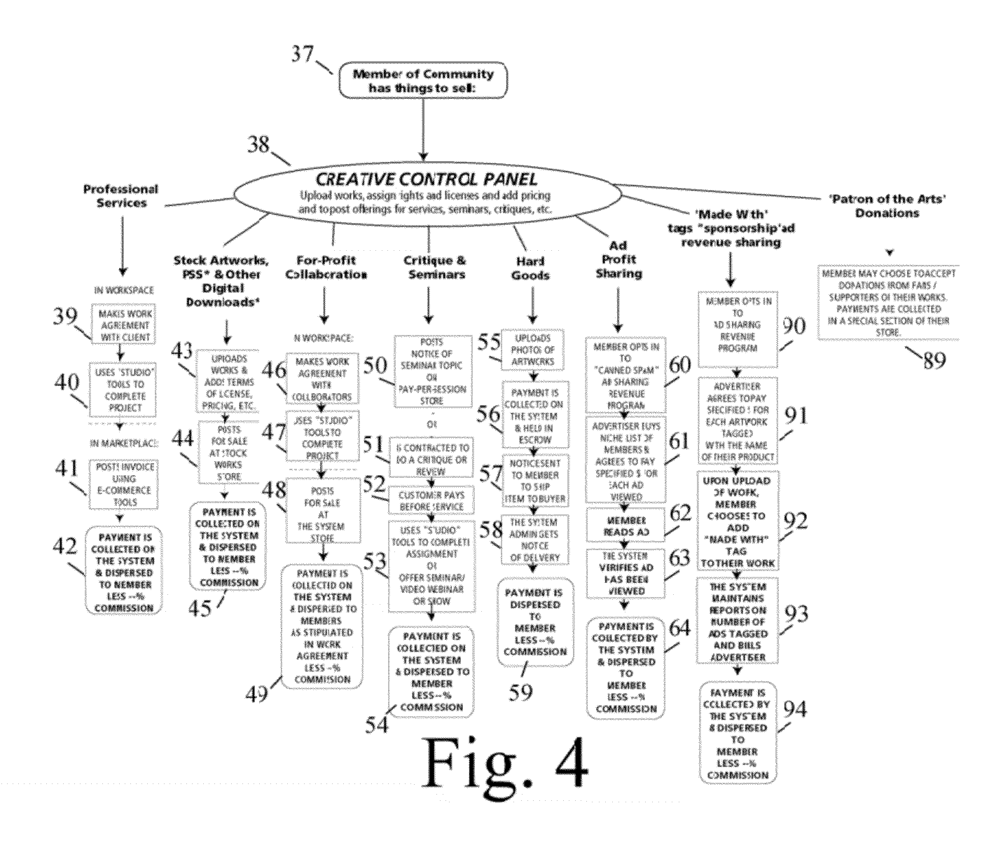

marketplace tools provide Members with e-commerce tools and methods that allow for multiple opportunities for revenue from one centralized web site as illustrated in FIG. 4. These tools allow Members to offer their services and sell their works online with the pricing, permissions, usage rights and formats that they choose. Works can be sold from the Collective store or Stock store—and/or—they can be sold from a Member's own individual web site—both accessing the invention's e-commerce system to process the payment and disbursement of fees. Members use the simple Creative Control Panel to set up and edit items for sale. Members may also opt-in to the “Canned-Spam” advertising revenue-sharing program, or choose to tag their works with a “Made With” sponsorship and share in the revenues collected by the system administration from the advertisers. Accounting records will allow members to track their sales and purchases within the system of the present invention and disperse funds from their system account to their personal accounts.

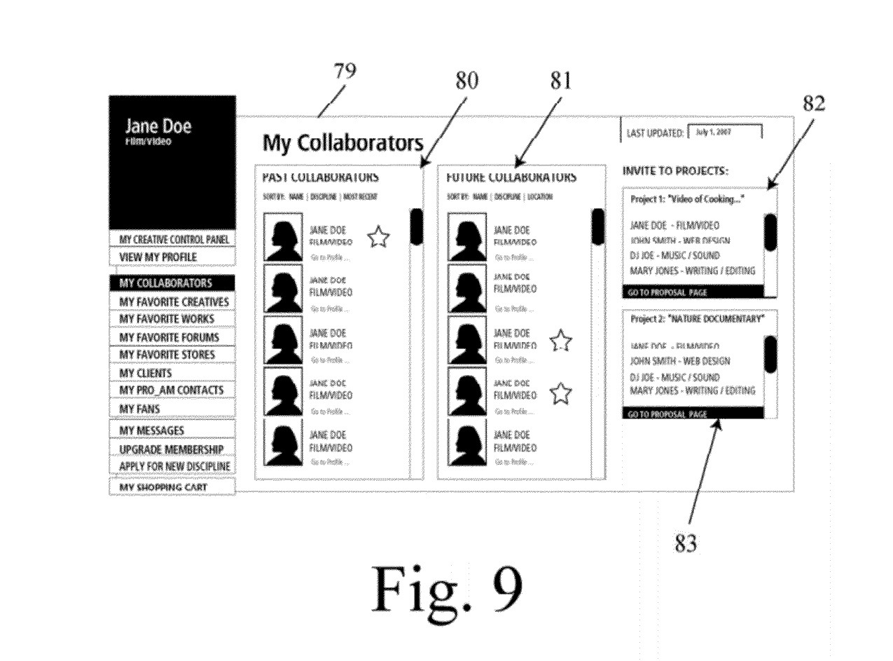

community tools enable members to build a dynamic community portal that involves Independent Contractors and their clients, customers and fans. Forums—both public and private (members only), contests, and news postings will generate continual fresh discussion and content for the site as well as draw traffic to the site, thereby increasing Members' opportunities to sell and promote their works to a broader audience. Users can register to set up their own page to keep track of their favorites and activities on the site. Now referring to FIG. 9, a sample Pro Member page is illustrated.

The present invention also includes a unique revenue producing and sharing concept that benefits the present invention's Collective members as well as advertisers. In this online advertising model, advertisers will buy private messaging access to members of a specific niche community (e.g. all photographers) of members that they choose. Advertisers pay the system of the present invention to send a direct message or offer to that exact number of members, e.g. for a price-per-address box. Members who have agreed to participate in the ad sales program will receive payment to the member accounts of the present invention for that message. The fee is directly dispersed to a Member's account and Members can choose to opt-out of the program thereby receiving none of the ad messages or the associated payments.

Pro Members may opt-in to another advertising-revenue sharing system referred to as “Made With” sponsorships in which an advertiser agrees to pay a fee to each Member who will attach a “Made With” tag to their works. For example, a photographer agrees to attach a “Made With Adobe Photoshop” to his photograph. This data displays with the photo when viewed on the site.

Now referring to FIG. 1, a schematic of overall site showing integration of tools and features is shown. The system is comprised on an software engine 1 that enables Internet-based back-end functionality such as databases, content management, file serving, communications, and e-commerce. A control panel 2 provides means for providing a user interface to manage a network, work samples, files, accounts, and projects. Through the control panel 2, a user can access community tools 3, showcase tools 4, workspace tools 5, and marketplace tools 6.

community tools 3 provide means for contest, awards, internal messaging, discussion forums, networking pages, favorite lists, mentoring, searching, and applications. Show case tools 4, provide means for creating and storing member profiles and information, portfolios, blogs, new postings, and customized websites and management tools. The engine 1 interacts with the showcase tools 4 providing custom templates organized through the control panel 2 interface.

Workspace tools 5 provide means for collaboration, including project proposals, division of tasks, fees, and deadlines. Workspace tools 5 also includes a collaboration Contract Wizard which provides means for users to generate custom agreements with rights assigned and profit sharing or payment schedules. Workspace tools 5 also includes a private Project Studio that is password protected for file sharing, job tracking, management of drafts and deliverables. Final invoice forms are also included in the Workspace tools 5 that provide means for billing and setting up dispersement of funds automatically to Members' accounts.

marketplace tools 6 include collective stores for selling works of all Pro Members including stock art, movies, songs, e-books, and all creative products. A Member's store sells works of individual members. Sharing stores allow Pro Members to post rights-free works that other Members can use free of charge. Pay-per-session critique and review and pay-per-view web shows and seminars and paid self-syndication are also included in the marketplace tools 6. Finally, members can opt-in to advertising revenue sharing programs as well.

FIG. 2 illustrates the process of becoming a Pro Member and using integrated Showcase tools to promote works and services. First an independent creative needs an easy way to promote works and services online to generate more business 7. Using the community tools 3, a creative member applies for membership in the collective with certain discipline requirements 8. A jury reviews the application for acceptance 9, and upon acceptance a member account is opened and the creative receives a Creative Control Panel 2 to build and edit showcase screens as well as being added to the directory and search features 10. From the Creative Control Panel 2, a creative can edit their Profile 18, edit their Portfolio 19, edit their Blog 21, edit RSS feeds and pod casts 16, and edit their domain 17. A Pro Member profile 18 includes areas of expertise, bio, honors, contact information, work methods for collaboration, location, and links to their own domain. The Portfolio 19 includes sample works organized into collections. From a Profile 18, Portfolio 19, Blog 21, or RSS feed 16 Pro Member's works and professional services are displayed and promoted as part of the system collective 14. A Member can choose and customize a CSS template 20, then assign content to the CSS template 15, manage the content on their individual website 13, and display and promote their work 12.

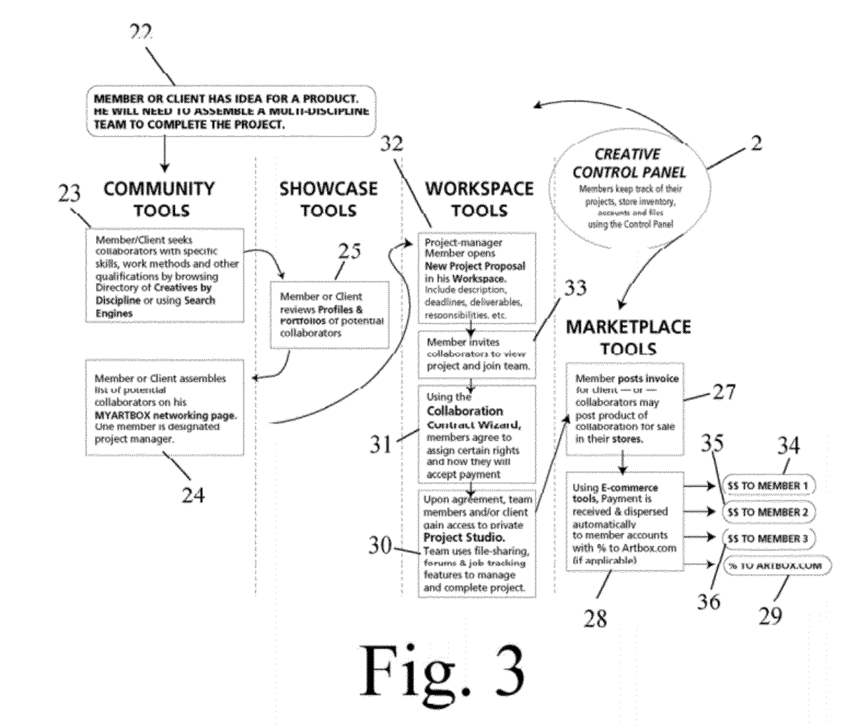

FIG. 3 illustrates the process of Pro Member and/or Client-Pro Member collaboration for profit using integrated tools and features. A Pro Member or Client has an idea for a product and must assemble a multi-discipline team to complete the project 22. The Pro Member uses the community tools 3 to seek collaborators with specific skills, work methods and other qualifications by browsing the directory of creatives by discipline or use the search engines 23. Using the Showcase tools 4, the Member can review Profiles and Portfolios of potential collaborators 25. A Member then assembles a list of potential collaborators on his networking page and designates one member as the project manager 24. Next, using the Workspace tools 5, a project manager member opens a new Project Proposal in his workspace including a description, deadlines, deliverables, and responsibilities 32. A Member invites collaborators to view the project and join the project team 33. Using the collaboration Contract Wizard, Members agree to assign certain rights relating the work each individual has contributed to the final product, and how they will accept payment 31. Upon agreement, team members and the client gain access to a private Project Studio. The team uses file sharing, forums, and job tracking to manage and complete the project 30.

marketplace tools 6 provide means for a Member to post invoices for clients, or collaborators may post products of collaboration for sale in their stores 27. Using the e-commerce systems of the invention, payment is received and dispersed automatically to Member accounts with a percentage being retained by the system 28. Funds can be distributed to one or more Members 29, 34, 35, and 36.

FIG. 4 illustrates a process of a Pro Member using marketplace tools for sale works and services and for ad profit sharing. The Pro Member has many things to sell and that are offered for sale 37. The Creative Control Panel provides means for the uploading works, assignation of rights and licenses, pricing, posting of offerings for service, seminars, and critiques 38.

Professional services are promoted and contracted in the Workspace and provide means for making a work agreement with a Client 39 and using Project Studio tools to complete a project 40. In the marketplace Member—Pro or Amateur—can post invoices using e-commerce tools 41 and payment is collected on the system and dispersed to the Members, less a commission if applicable 42.

Stock artworks, Paid Subscription-only Blogs, Paid Self Syndication works, and other digital downloads are enabled by uploading works and adding terms of license and pricing 43. Posts for sale at stock works store 44 provide means for a sale and payment is collected on the system and dispersed to member, less a commission if applicable 45.

For-profit collaboration is enabled in the workspace. A Pro Member makes a work agreement with collaborators using the Contract Wizard. 46. The Members uses Workspace tools to complete a project 47 and it is posted for sale at the system stores of the Members' choosing. 48. Payment is collected on the system and dispersed to the individual Members, less a commission 49.

critique and seminars are provided that allows Pro Members to post notices of seminar topics on a pay-per-session basis 50 or Pro Members are contracted to do a critique or review 51 where a customer pays for the service 52. The Pro Member uses Workspace tools to complete a project 53 or offer seminars or video webinar shows. Payment is collected on the system and dispersed to the Pro Member, less a commission 54.

Hard goods can be uploaded e.g. photos, music CDs, paintings or artwork 55. Payment for hard goods is collected by the system and held in escrow 56 and a notice is sent to a Member to ship the item to the buyer using a system-approved, verifiable and secure carrier 57. The system gets a notice of delivery 58 and payment is dispersed to a Member less commission 59.

“Canned Spam” allows Members to opt-in to an advertising revenue sharing program 60. An advertiser buys a niche list of Members from the system administrators and agrees to pay specified money for each advertising message as viewed 61. A Member reads the ad 62 and the system verifies the ad has been read 63 and payment is dispersed to a member 64. Pricing for these ad messages, and therefore payment to Members would be scaled depending on the level of response requested by the advertiser. e.g. Advertisers would pay members more for a 20-question survey; less for a simple “image ad.” The incentive to opt-in to this program benefits the Members of the Collective by offering them another potential source of revenue.

Pro Members may opt-in to another advertising revenue-sharing program 90 in which an advertiser agrees to pay a specified amount for each artwork tagged with the name of their product 91 and the Member may choose to add a “Made With” tag 92 to the meta data of their works which gives credit to the software or other brand-name tools that were used to create that work. The system of the present invention maintains reports on the number of ads tagged and bills the advertiser 93. Payment is colleted by the system and dispersed to the member less a commission 94. For example, a photograph may be tagged with a “Made with Adobe Photoshop” tag. The brand-name tool company becomes a “sponsor” of that work, and a fee is paid to the Member for placing that tag on the work. Fees are tracked and dispersed using the systems marketplace tools.

Pro Members may opt-in to accept “Patron of the Arts” donations from Fans 89 who admire and want to support their work.

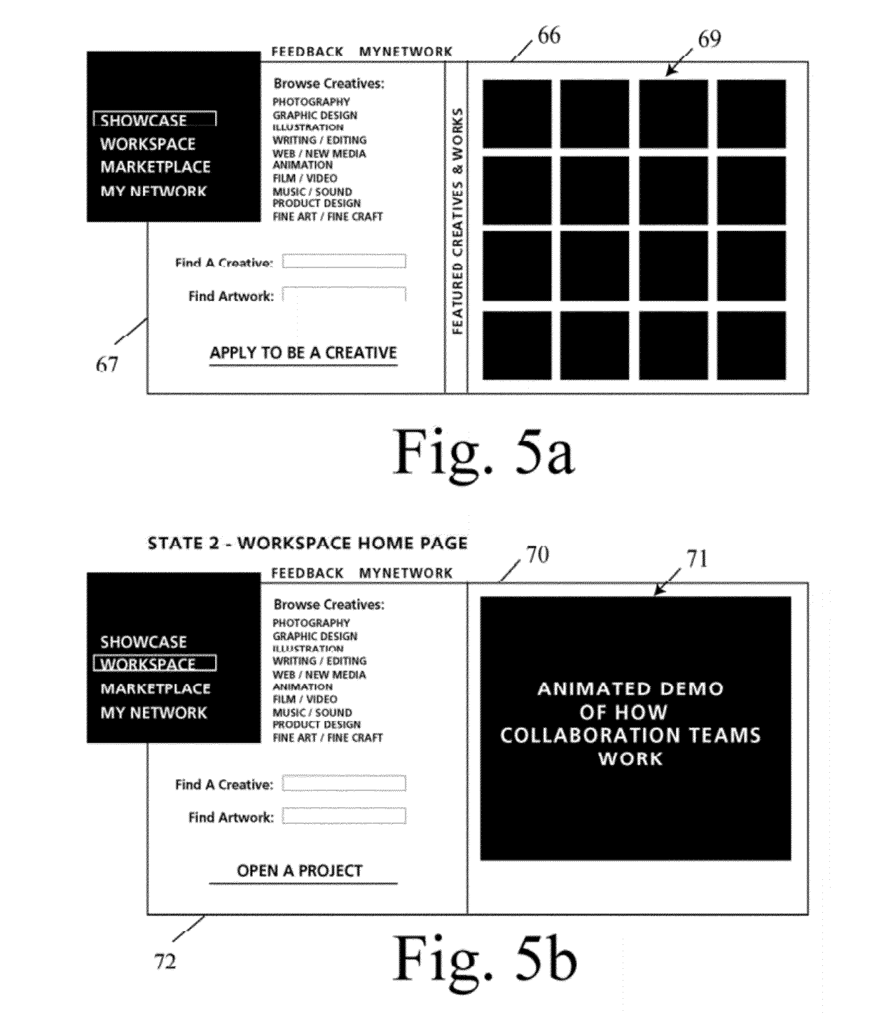

FIGS. 5a and 5b show the home page states for Showcase and Workspace tools 67. Within a right hand panel of the Showcase web page 66 a rotating display of Pro Members and their works, clickable for more detail 69 is shown. Within a right hand panel 70 of the Workspace “home” page state 72 an animated demo 71 of how the system collaboration teams work may be displayed.

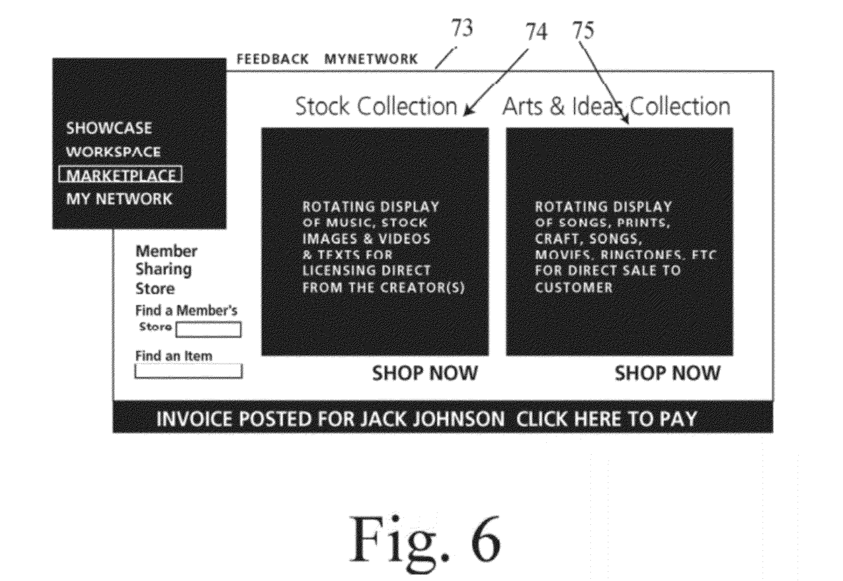

FIG. 6 shows the marketplace home page state 73 that promotes works for sale in the general collective store 75 and in the Stock—Licensed Works collection 74. Pro Members only get a link to the Member's Sharing Stores. There is a Search for the Pro Members' stores and to find specific objects. When a client has hired, and owes payment to, an individual member or a collaborative team of members, there will be a large notice on this screen that an invoice has been posted for the job. There will be a similar notice for PSS subscribers.

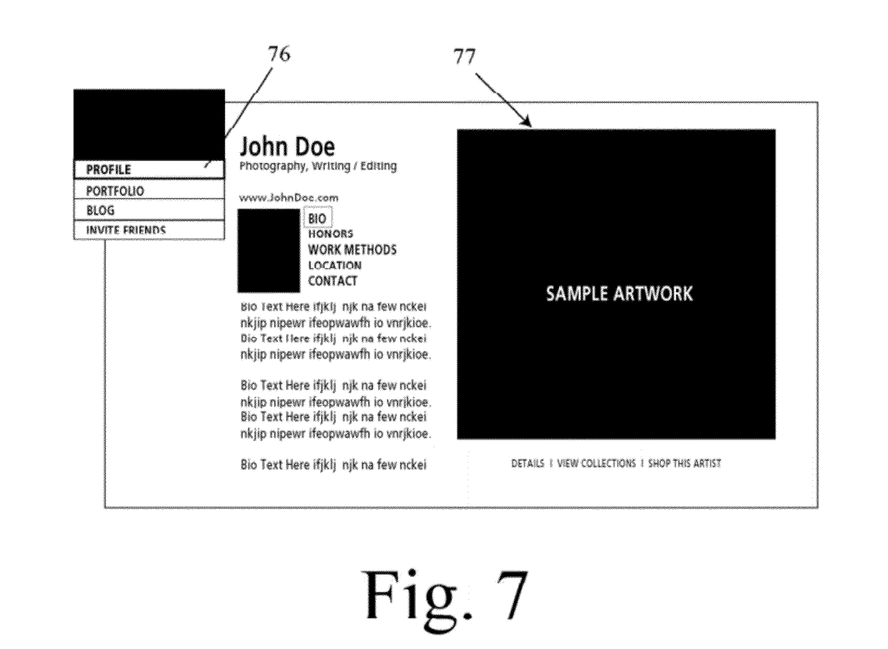

FIG. 7 shows the Profile screen menu of the Showcase 76 that toggles to display the Member's bio, qualifications, and work methods for collaboration and the Member's Portfolio, blog, and a link to the Member's own domain web site. There is also a right hand panel 77 that provides viewing of sample artwork.

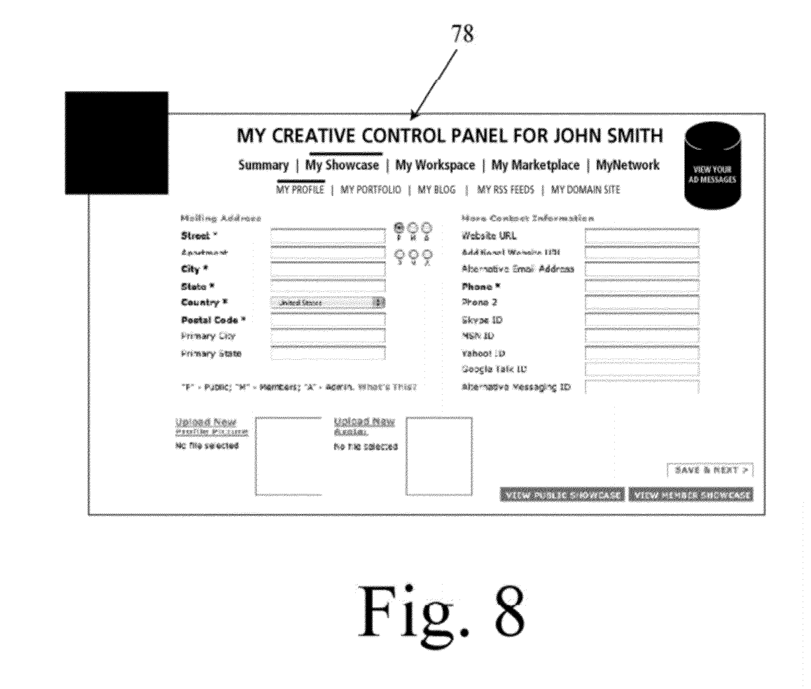

FIG. 8 illustrates a Pro Member's Creative Control Panel 78; site functions for the Member are controlled through interface with the Creative Control Panel. A menu at the top organizes the integrated tools and allows a private back-end page where Members can review their accounts, edit their profiles, upload their works and organize them into collections, assign rights and pricing, and manage collaborations with clients and other members; and post items for sale in the individual stores, etc. Features can be added and controls can be added here.

“Canned Spam”, and ad-revenue sharing messages are posted on these screens for the member to access and to be paid for viewing.

FIG. 9 illustrates a Pro Member's pages for keeping tracking of their favorites, receiving and sending messages, and reviewing purchases. Members, Fans, and Clients can have similar personal pages once registered on the web site of the system. They will have different options available to them in their menus depending on their membership status. These pages can be where users keep track of their favorites, receive and send intranet messages, and review purchases on the system site. For illustrative purposes, FIG. 9 shows a Pro Member's screen 79 that shows past collaborators 80, future collaborators 81, and a project tracker for a first project 82 and a second project 83.

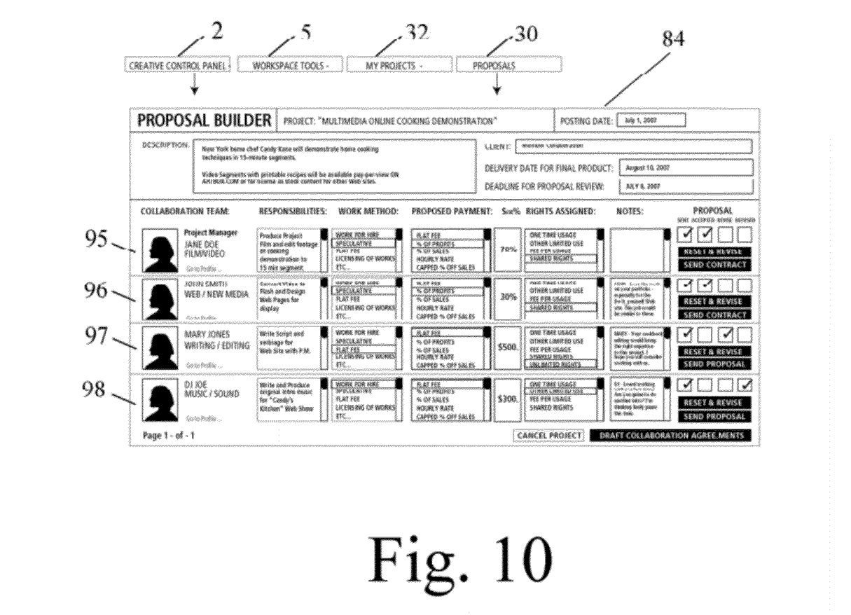

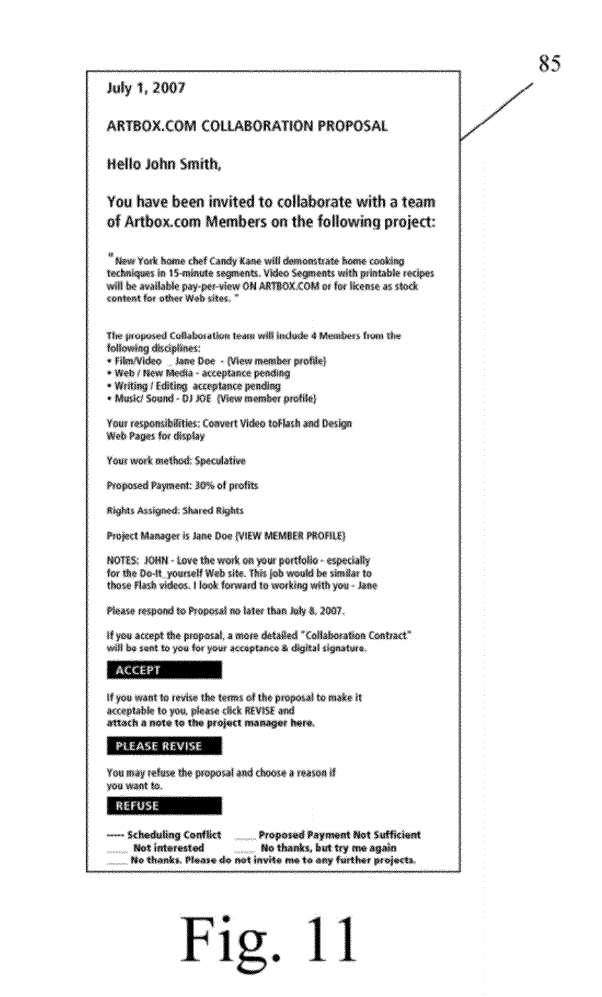

FIG. 10 illustrates a Proposal/Invitation to Collaborate tool 84. A collaboration team leader or Project Manager 95 opens the “Project Studio” Workspace 84 for the collaborators 96, 97, and 98 and they are admitted once they have accepted the collaboration agreements. A project manager 95 fills out these fields and the system assembles them into a private electronic message format, which is automatically delivered to the Pro Members listed as an invitation to join the project and proposal of the work arrangements. Once all members have accepted, the project manager selects “draft collaboration agreements” to bring up the collaboration Contract Wizard which will be pre-filled out with these sections but have more detailed explanation of items. FIG. 11 illustrates sample text of an invitation to collaborate message 85.

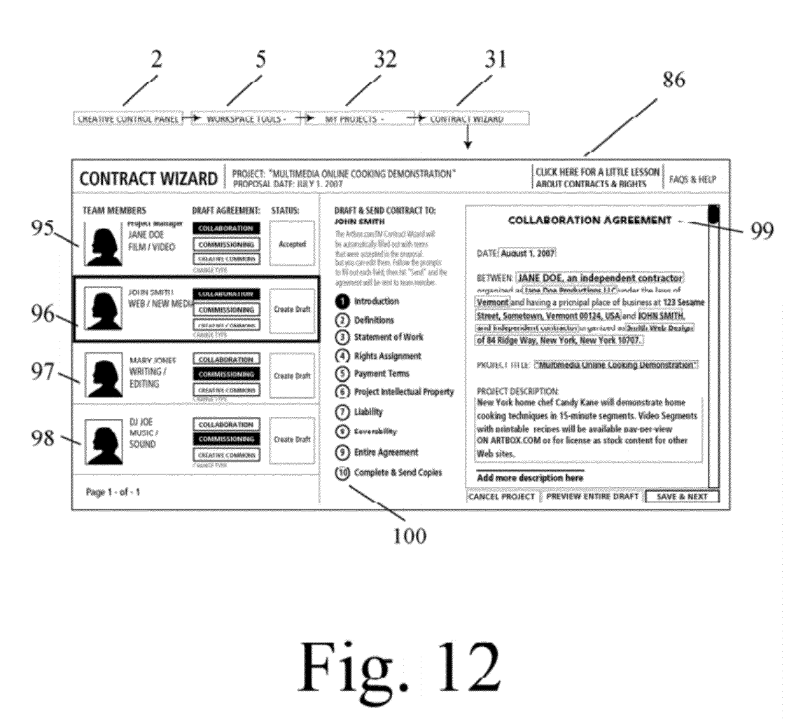

FIG. 12 illustrates the collaboration “Contract Wizard” 86 of the present invention. A project manager uses the collaboration “Contract Wizard” to draft a collaboration agreement or a commissioning agreement 99 between Members working on a project. An individual agreement 85 is drafted for each Member as illustrated in FIG. 11, but the fields of the boilerplate are pre-filled in by information from the Member's Profile as in FIG. 8 and the proposal wizard as discussed in FIG. 11. The contract wizard 31 goes through each section of the agreement step-by-step for ease of drafting the contract 100. At the end, the draft is saved and sent via private electronic message to the members. They can each sign it digitally to accept the terms, and the contracts are archived in their projects space on their Creative Control Panels.

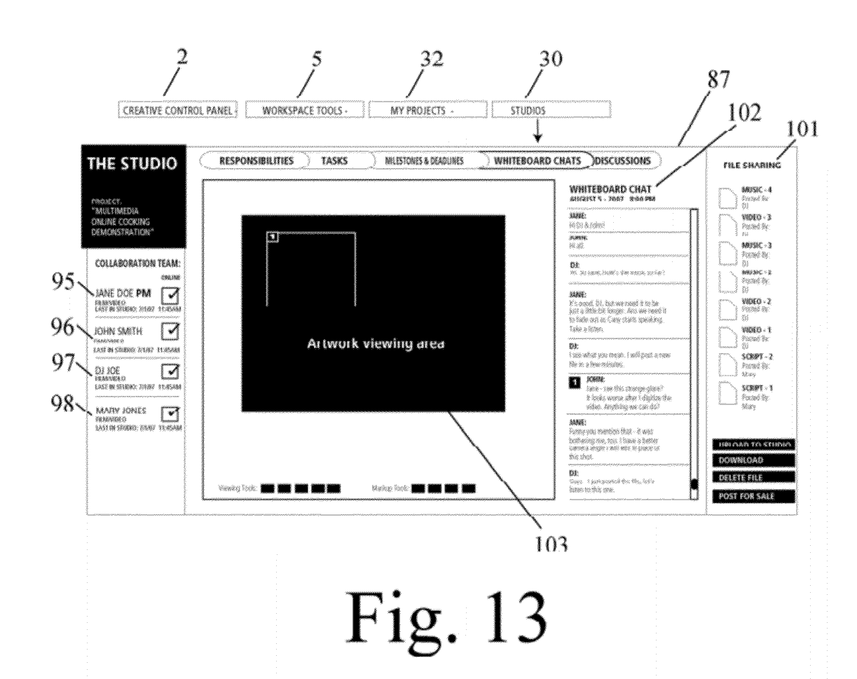

FIG. 13 illustrates a “Studio” Workspace 87 for the collaborators that offers areas for viewing 103, file and job tracking 101 and discussions 102 about the files; Collaborators are admitted once they have accepted the collaboration agreement pertaining to that specific project.

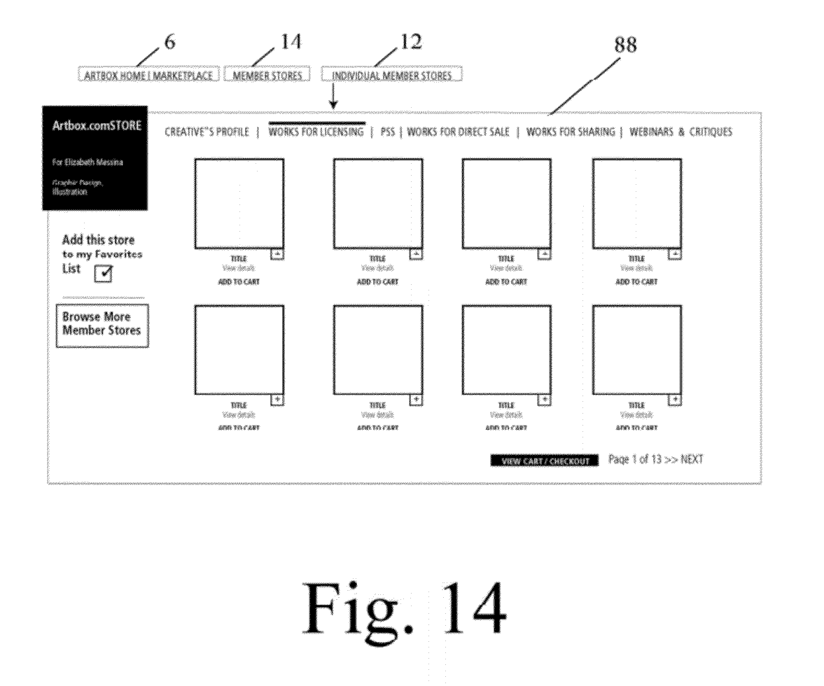

FIG. 14 illustrates a Pro Member store screen 88. Customers access this store from the home page, by using the system's search and browse functions, or through a Pro Member's Profile page. Users can browse several Pro Member stores and add items to a single shopping cart. The e-commerce tools will disperse payments automatically to the individual Members and take a pre-determined percentage as commission when applicable.

Now referring to FIG. 15, the “Paid Self-Syndication” (also referred to as “PSS”) process by which a member offers original works for syndication by paid subscription is illustrated. A Pro Member wanting to offer his works for direct sale or for resale uses his Control Panel 2 to move works to a “PSS” folder. The Member has set certain permissions for this folder so that all works deposited in this collection will be tagged with the same instructions such as usage terms, pricing and where it can be posted for sale. 105 The collection works is then automatically listed for sale at the pre-designated “stores”, which may include the system's collective “PSS Store”, the Pro Member's Store, and/or the Pro Member's own domain site which is “powered by” the system's engine and tied into the system's e-commerce tools 106.

After payment is received from a fan for personal use or a client purchasing for reuse, it is sent to the Pro Member's account 108 and a portion is retained by the system as a commission (if applicable) 109. Once paid, the work is automatically loaded to a list of PSS subscriptions where the fan or client can access the most recent work and other member's works to which he is subscribed 107. If a work has been purchased for reuse or resale, the buyer can insert the work, depending on the terms of subscription, in another medium for distribution and/or resale 110.

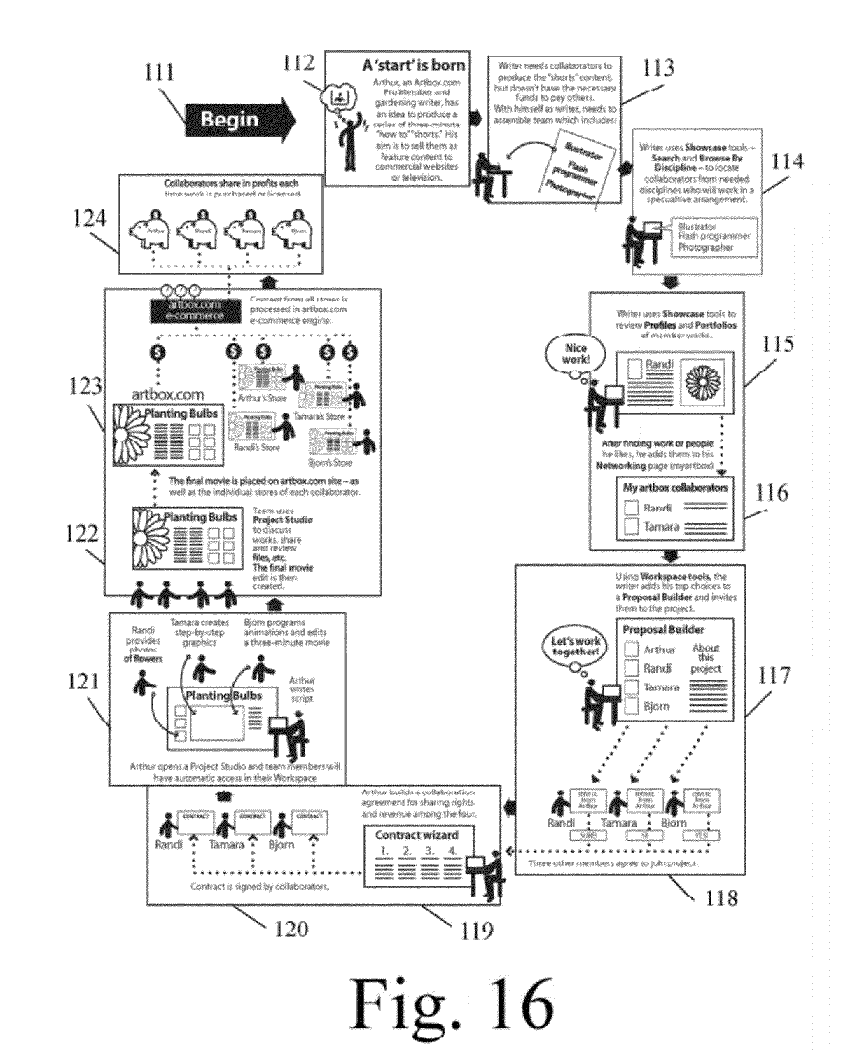

FIG. 16 illustrates the general process by which a Pro Member uses the integrated processes of the invention to assemble a multi-discipline team, agree to share profits and rights using the Contract Wizard, complete a project using the Workspace tools, and offer the resulting work for sale on the system web site as well as the Member's own domain sites which are ‘powered’ by the back-end ‘engine” of the invention. A Pro Member begins 111 when an idea to create a work is formed 112. Collaborators are then required to create the work 113 and by using the showcase tools collaborators are searched 114. The showcase tools allow a member to search potential collaborator portfolios and profiles 115 when the member can then add to his network page 116. Using the workspace tools, the member can crate a proposal to send to each potential collaborator 117 and then send individual invitations 118 for acceptance or rejection. After acceptance from collaborators, the member then uses the contract wizard to create a collaboration agreement for sharing rights and revenues between the member and collaborators 199. The contract is then executed by the collaborators 120 and the member uses the project studio to start the project and connect each collaborator 121. The collaborators use the project studio to discuss the work, and share and review drafts of the work 122. After completion, the work is placed on the system website and market place as well as each individual collaborators store 123. The system process and records sales and distributes revenue per the collaboration agreement 124.

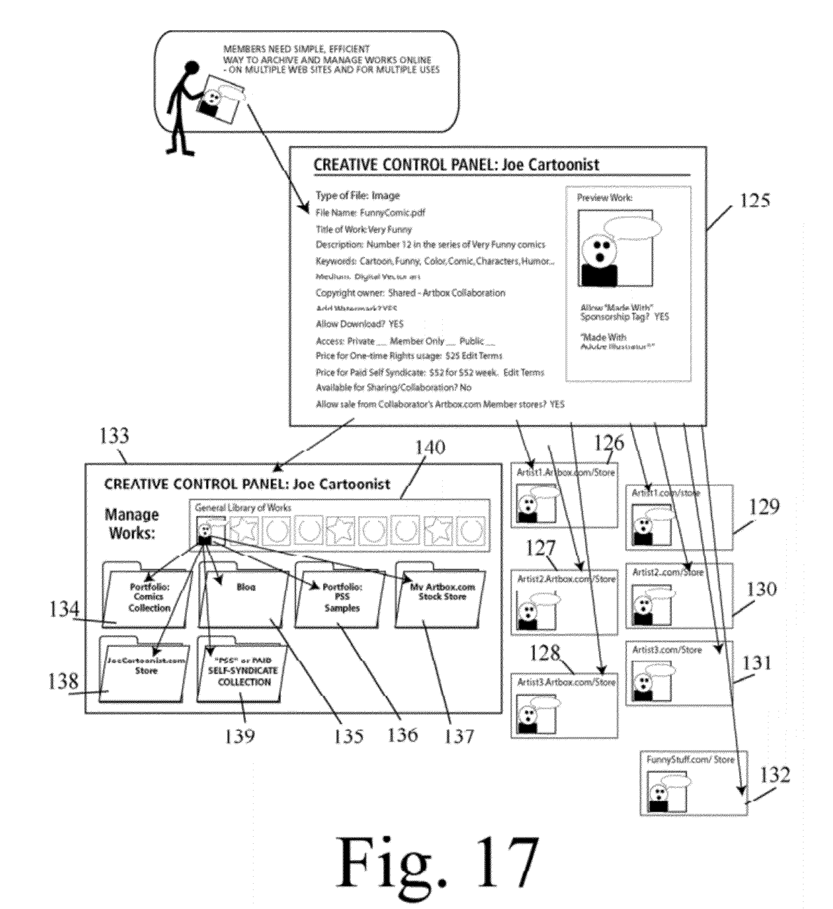

FIG. 17. illustrates the “Upload Once” process by which a single work is uploaded to the site and subsequently tagged with meta data that gives information about the work, sets permission, sets preferences as to display and usage, pricing, rights-management, copyright ownership, “Made With” sponsorship, and is then distributed through Member stores for sale or licensing, dispersement of sales revenues, etc. all managed by the Creative Control Panel and powered by the invention's unique engine. A member uploads works to a general library section of his control panel which then adds meta data tags which give information, preferences and permissions about how and where the work is viewed, used, licensed, and sold 125. For each work, the member's creative control panel 133 provides access to the general library works 140 which, in turn, enables access to the work from the member's portfolio 134, blog 135, PSS 136, system stock store 137, personal store 138, or PSS collection 139. A work can be sold from a Member's own stores on the system 126, 127, and 128 if they have agreed in advance or work can be sold form collaborators own domain web sites 129, 130, 131. Works can also be sold from a third party web site 132 that is tied into the system's e-commerce component.

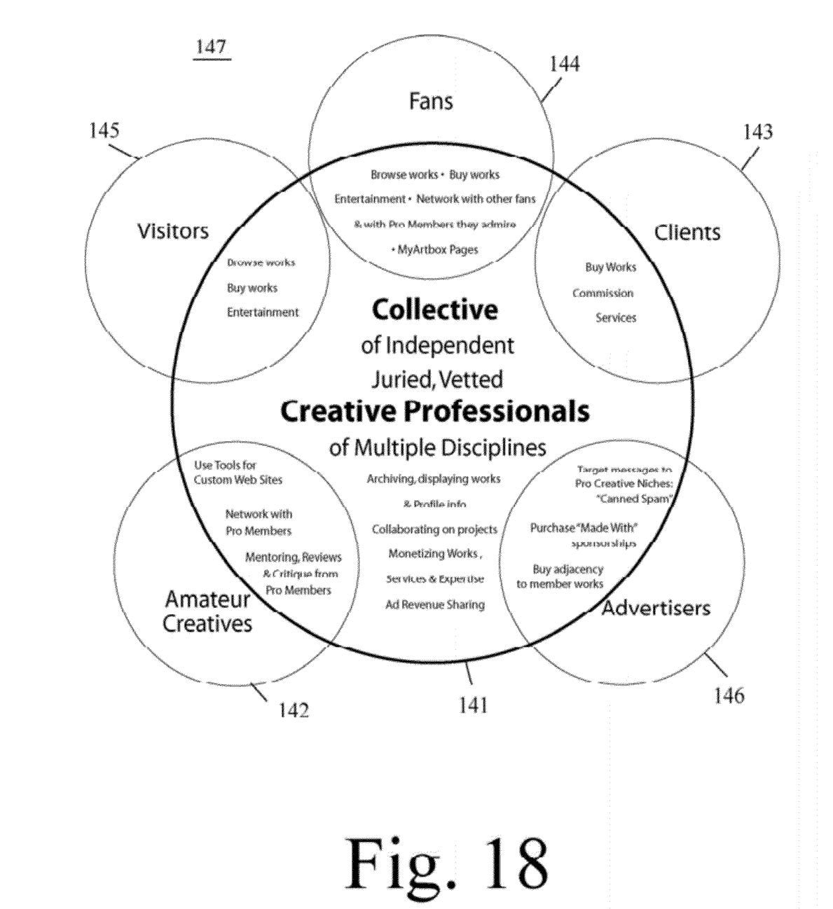

FIG. 18 illustrates how the collective aggregation of top-quality Pro Members attracts other users to the system of the present invention, thereby creating a dynamic economic and social online community 147. It demonstrates the classifications of other users by their purpose or status—Amateur Members 142, Clients 143, Fans 144, Visitors 145, and Advertisers 146, and their relationships to the Collective of Pro Members 141. The collective of Pro Members 141 have the ability to archive and display works in a profile, collaborate on project, monetize works, provide service and expertise, and participate in ad revenue sharing programs. Advertisers 146 can provided targeted messages to niche markets using canned spam, buy adjacency to member works, and purchase “made with” sponsorships. Clients 143 can buy works, commission works, or offer services to the community 147. Fans 144 can browse works, buy works, network, and crate personal website pages. Visitors 145 can browse works, buy works, and receive entertainment. Amateur creatives 142, can use the system of the present invention as a tool to create custom websites, network with Pro Members, and receive mentoring, reviews, and critique from Pro Members of their works—all through one online location with just one login.

The foregoing is considered as illustrative only of the principles of the method. Since numerous modifications and changes will readily occur as technology, software and hardware advances evolve, it is not desired to limit the invention to the exact construction and operation shown and described, and accordingly, all suitable modifications and equivalents may be resorted to, falling within the scope of the method and invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A method for creating an online collective of independent contractors from multiple disciplines and specialties recorded on computer-readable medium and capable of execution by a computer, the method comprising the steps of:
providing an Internet-based software engine consisting of integrated databases, content-management systems, file serving, communications and e-commerce processes;
providing a control panel graphical interface on a website controlled by the software engine;
providing a showcase tools on a website controlled by the software engine;
providing a member profile and portfolio page on a website controlled by the software engine;
creating customized web sites integrated with the website controlled by the software engine;
providing workspace tools consisting of integrated software tools on a website controlled by the software engine;
providing project studio pages on a website controlled by the software engine;
providing marketplace tools on a website controlled by the software engine; and
providing community tools on a website controlled by the software engine.

2. The method of claim 1, further comprising
contracting of professional services directly to public consumers and clients—through contacts or with project-management tools;
selling original works and hard goods directly to public consumers and other members through a system store;
selling original works and hard goods directly to public consumers and other members through a third party website;
selling original works and hard goods directly to public consumers and other members through a member's own web site store powered by the software engine;
selling digital download copies works through a system store;
selling digital download copies works through a member's own web site store powered by the software engine;
licensing works through a system store;
licensing works via download through the member's own web store powered by the software engine; and
selling professional services and contracting work to other members through the system;
wherein members can offer licenses for sale to clients for resale;
wherein members can offer licenses for sale to users for personal use; and
wherein members can offer licenses for sale to third parties for resale.

3. The method of claim 1, further comprising enabling for-profit collaboration projects with other members in which a team of members, in a speculative arrangement, combine their specialties to create a work, agree in advance to how profits will be shared among them, and sell that work or copies of it from the system store as well as their own individual stores; and
providing a members' payment shares to be automatically dispersed to their system accounts immediately upon sale of a work.

4. The method of claim 1, further comprising
creating paid critique and reviews;
charging for critique and review services via the system's collaboration tools; and
providing online seminars;
creating and offering online seminars, speeches or lessons that will be viewable or downloadable for a fee.

5. The method of claim 1, further comprising an Advertising Revenue Sharing program wherein members automatically receive a payment for each pay-per-mailbox electronic advertisement message that they choose to view.

6. The method of claim 1, further comprising:
providing a Paid Self-Syndication;
setting up accounts for subscribers which gives them access to a select group of files available by automatic addition to a list of download links on that subscriber's password-protected page; and
pricing and licensing files per rates and terms pre-negotiated with the member.

7. A method for creating an online collective of independent contractors from multiple disciplines and specialties comprising:
providing an Internet based back-end comprising databases, file-serving, content management, communications, and e-commerce functions;
managing a network through a web-based control panel providing a user interface to manage the network, work samples, files, account, and projects; and
accessing community tools, Showcase tools, Workspace tools, and marketplace tools through the user interface.

8. The method of claim 7, further comprising
creating and storing member profiles and information, preferred work methods, portfolios and collections of sample works, blogs, new postings'
providing customized websites and management tools; and
providing custom templates organized through the control panel interface by the engine interacting with the showcase tools.

9. The method of claim 7, further comprising
providing collaboration, including project proposals, division of tasks, fees, and deadlines;
providing a collaboration contract wizard which generates custom agreements with rights assigned and profit sharing or payment schedules;
accessing a private studio that is password protected for file sharing, job tracking, management of drafts and deliverables within the Workspace tools; and
providing final invoice forms in the workspace and marketplace tools for billing and setting up dispersement of funds automatically to a member's accounts.

10. The method of claim 7, further comprising marketplace tools
providing collective stores for selling works of all members;
sharing stores allowing members to post rights-free works that other members can use free of charge;
providing pay-per-session critique and review and pay-per-view web shows and seminars and paid self-syndication; and
offering opt-in to an advertising revenue sharing program.

11. The method of claim 8, further comprising showcase tools:
displaying and promoting works and services;
applying for membership in the collective with certain discipline requirements;
reviewing the application for acceptance by a jury;
receiving a control panel and a member account to build and edit showcase screens and being added to the directory; and
editing a profile, portfolio works, blog, RSS feeds pod casts, and domain.

12. The method of claim 7, further comprising:
assembling a multi-discipline team to complete a project;
using community tools to seek collaborators with specific skills, work methods and other qualifications;
browsing the directory of creatives by discipline;
reviewing profiles and portfolios of potential collaborators;
assembling a list of potential collaborators on a networking page and designating one member as the project manager;
opening a new project proposal in his workspace including a description, deadlines, deliverables, and responsibilities;
inviting collaborators to view the project and join the team;
utilizing a collaboration contract wizard wherein members agree to assign certain rights and how they will accept payment;
providing access to private project studio; and
providing file sharing, forums, and job tracking to manage and complete the project.

13. The method of claim 10 comprising:
posting invoices for clients;
posting products of collaboration for sale;
receiving and dispersing payments to member accounts; and
retaining a percentage being retained as commission.

14. The method of claim 10 comprising:
uploading works, assignation of rights and licenses, pricing;
posting of offerings for service, seminars, and critiques through a graphical interface control panel;
tagging and distributing uploaded works to one or more web pages and one or more domains for a plurality of purposes and uses;
making a work agreement with a client and using studio tools to complete a project;
posting invoices using e-commerce tools; and
collecting payment on the system and dispersing to a member, less a commission.

15. A method for creating an online collective of independent contractors from multiple disciplines and specialties recorded on computer-readable medium and capable of execution by a computer, the method comprising the steps of:
organizing and integrating web-based tools as a software engine;
providing a combination and integration of online tools and services for the purpose of streamlining collaborative efforts among members and making it easy to sell or license original works and services direct to consumer and clients;
means for a Control Panel which allows members to upload each of their original digital files once to the present invention's server and manage how those files are displayed, shared or sold online;
providing showcase tools that enable members to build and edit portfolios works and post electronic or digital works of multiple formats, and maintain a personal blog;
creating a Member Showcase A Members' professional information is included in an individual Showcase page as well as in searchable online listings that help users to locate professionals of specific specialty areas;
providing customized web sites; and
providing workspace tools to members with a collection of integrated software tools, so that members can find and collaborate with other members and or their clients to invent, discuss, develop, critique, project-manage and create works that can be sold from the present invention web site and/or from individual members' web sites.

16. The method of claim 15 further comprising:
providing private Project Studios or collaboration spaces where works in progress or for potential sale can be discussed, tagged, critiqued and available for access and distribution; and
providing a Paid Self Syndication wherein users may subscribe to a member's or group of members' works for pre-negotiated license terms and fee scales, exclusivity, right of first refusal.

17. The method of claim 15 further comprising:
providing marketplace tools;
providing e-commerce tools and methods that allow for multiple opportunities for revenue from one centralized web site;
selling works online with selected pricing, permissions, usage rights and formats; and
providing accounting records to track sales and purchases and disperse funds to personal accounts.

18. The method of claim 15, further comprising:
building a dynamic community portal that involves independent contractors and their clients, customers and fans;
providing an online advertising model wherein advertisers will buy private electronic messaging access to members of a specific niche community of members that they choose;
paying advertisers to send a direct message or offer to that exact number of members for a price-per-system address box;
providing payment for the verified viewing of a message; and
dispersing fees to a member's account; and
providing an opt-out choice.

19. The method of claim 15 further comprising the step of:
providing a single file upload; and
tagging and distributing the file to one or more web pages and one or more domains.
